(19) United States
(12) Patent Application Publication
(10) Pub. No.: US 2012/0250819 A1
(43) Pub. Date: Oct. 4, 2012

(54) DETECTOR MODULE AND RADIATION IMAGING APPARATUS

(75) Inventors: Masaru Yoshida, Tokyo (JP); Masahiro Moritake, Toyko (JP); Koji Bessho, Tokyo (JP)

(73) Assignee: GE MEDICAL SYSTEMS GLOBAL TECHNOLOGY COMPANY, LLC, Waukesha, WI (US)

(21) Appl. No.: 13/433,735

(22) Filed: Mar. 29, 2012

(30) Foreign Application Priority Data
Mar. 31, 2011 (JP) 2011-076935

(51) Int. Cl. G01N 23/04; G01T 1/20; G01T 1/16

(52) U.S. Cl. 378/4; 250/394; 250/366

(57) ABSTRACT

A radiation imaging apparatus is provided. The radiation imaging apparatus includes a radiation detector including a plurality of detector modules disposed therein, each detector module including a plurality of radiation detecting elements, wherein each of the detector modules includes a temperature sensor. The radiation imaging apparatus further includes an acquiring device configured to acquire temperature characteristic information of sensitivities of the radiation detecting elements from a storing device in which the temperature characteristic information is stored in advance, and a correcting device configured to correct data detected by the radiation detecting elements, based on temperature information acquired by the temperature sensor and the temperature characteristic information acquired by the acquiring device.

### CROSS REFERENCE TO RELATED APPLICATIONS

This application claims the benefit of Japanese Patent Application No. 2011-076935 filed Mar. 31, 2011, which is hereby incorporated by reference in its entirety.

### BACKGROUND OF THE INVENTION

The present invention relates to a detector module, and a radiation imaging apparatus equipped with the detector modules.

There has heretofore been known an X-ray imaging apparatus equipped with an X-ray detector in which a plurality of detector modules each including a plurality of X-ray detecting elements are disposed.

In general, the sensitivity of the X-ray detecting element varies depending on the X-ray detecting elements. In the X-ray imaging apparatus, however, subject data obtained by imaging or capturing a subject is corrected using data obtained by imaging a reference substance such as water, air or the like, in such a manner that the relationship between an X-ray absorption coefficient of a substance and a pixel value of a captured image becomes effective as prescribed.

On the other hand, the sensitivity of each X-ray detecting element has a temperature characteristic that varies depending on the temperature of the X-ray detecting element. For this reason, when there is a difference between an element temperature at the imaging of the reference substance and an element temperature at the imaging of the subject, the subject data cannot be corrected accurately, and an artifact occurs in the captured image.

There has therefore been proposed a method for correcting a variation in the output of each X-ray detecting element due to fluctuations in element temperature, using the temperature characteristic of the sensitivity of each X-ray detecting element, the element temperature at the imaging of the reference substance and the element temperature at the imaging of the subject See for example, Japanese Patent Publication Laid-Open No. Sho 62-231628.

Incidentally, the temperature characteristic of the sensitivity of the X-ray detecting element also actually varies according to the X-ray detecting elements. When the detector modules differ in particular, their temperature characteristics may greatly vary due to differences in manufacturing conditions.

Thus, for example, a reference substance is imaged at a plurality of different element temperatures, and temperature characteristics of the sensitivity for every X-ray detecting element are determined from data obtained at this time and stored. Data obtained by the respective X-ray detecting elements are corrected based on the temperature characteristics of the sensitivities of the X-ray detecting elements.

When, however, the detector module is replaced with another one due to malfunctions or the like, it is necessary to image a reference substance at a plurality of different element temperatures on a case-by-case basis, and determine a temperature characteristic of sensitivity of each X-ray detecting element at the newly-disposed detection module. This therefore takes time and effort over an imaging preparation.

With such a situation, it is desirable to make unnecessary imaging for redetermining temperature characteristic information of sensitivities of X-ray detecting elements, necessary for temperature correction of detected data and prevent time and effort from being taken over the imaging preparation.

### BRIEF DESCRIPTION OF THE INVENTION

In a first aspect, a radiation imaging apparatus is provided. The radiation imaging apparatus includes a radiation detector having plural detector modules disposed therein, each including a plurality of radiation detecting elements, wherein each of the detector modules has a temperature sensor, and the radiation imaging apparatus further includes an acquiring device for acquiring temperature characteristic information of sensitivities of the radiation detecting elements from a storing device having stored the temperature characteristic information in advance in detector module units outside the radiation imaging apparatus, and a correcting device for correcting data detected by the radiation detecting elements, based on temperature information by the temperature sensor and the temperature characteristic information acquired by the acquiring device.

In a second aspect, the radiation imaging apparatus according to the first aspect is provided, wherein the storing device is provided in each of the detector modules.

In a third aspect, the radiation imaging apparatus according to the first aspect is provided, which has a reading unit, wherein the storing device is a storage medium readable by the reading unit.

In a fourth aspect, the radiation imaging apparatus according to the first aspect is provided, wherein the storing device is connected to the radiation imaging apparatus through a network.

In a fifth aspect, the radiation imaging apparatus according to any one of the first to fourth aspects is provided, wherein the temperature characteristic information include typical temperature characteristic information of the detector modules, and the correcting device corrects data detected by the individual radiation detecting elements that configure the detector modules respectively, based on the typical temperature characteristic information of the detector modules.

In a sixth aspect, the radiation imaging apparatus according to any one of the first to fourth aspects is provided, wherein the temperature characteristic information include typical temperature characteristic information for every group when the radiation detecting elements that configure the detector modules are divided into a plurality of groups, and the correcting device corrects data detected by the radiation detecting elements lying in the same group, based on the typical temperature characteristic information of the groups.

In a seventh aspect, the radiation imaging apparatus according to any one of the first to fourth aspects is provided, wherein the temperature characteristic information include temperature characteristic information for every radiation detecting element configuring each of the detector modules, and the correcting device corrects the data detected by the radiation detecting elements, based on the temperature characteristic information of the radiation detecting elements.

In an eighth aspect, the radiation imaging apparatus according to any one of the first to seventh aspects is provided, wherein when the detector module is replaced with a new detector module, the correcting device acquires temperature characteristic information corresponding to the new detector module.

In a ninth aspect, the radiation imaging apparatus according to any one of the first to eighth aspects is provided, wherein the correcting device performs the correction, based on temperature information by the temperature sensor at the time that water or air is imaged, and temperature information by the temperature sensor at the time that a subject to be captured is imaged.

In a tenth aspect, the radiation imaging apparatus according to any one of the first to ninth aspects is provided, wherein the radiation detecting element includes a scintillator and a photodiode, and the temperature characteristic information include information related to temperature characteristics of outputs of the photodiodes.

In an eleventh aspect, the radiation imaging apparatus according to the tenth aspect is provided, wherein the temperature characteristic information includes information related to a temperature characteristic of an output of the scintillator.

In a twelfth aspect, the radiation imaging apparatus according to any one of the first to ninth aspects is provided, wherein each of the radiation detecting element includes a scintillator, a photodiode and a circuit which receives the output of the photodiode as an input, and the temperature characteristic information include information related to temperature characteristics of outputs of the circuits.

In a thirteenth aspect, the radiation imaging apparatus according to any one of the first to twelfth aspects is provided, wherein the temperature characteristic information include information indicative of variations in gain and/or offset relative to the temperature.

In a fourteenth aspect, the radiation imaging apparatus according to any one of the first to twelfth aspects is provided, wherein the temperature characteristic information include a correction operational equation and/or correction coefficients used for the correction of the detected data.

In a fifteenth aspect, the radiation imaging apparatus according to any one of the first to fourteenth aspects is provided, wherein the temperature sensor is disposed on the side opposite to the radiation incident side of each of the detector modules.

In a sixteenth aspect, the radiation imaging apparatus according to any one of the first to fifteenth aspects is provided, wherein the temperature sensor is a platinum temperature sensor.

In a seventeenth aspect, the radiation imaging apparatus according to any one of the first to sixteenth aspects is provided, which performs X-ray CT imaging.

In an eighteenth aspect, a detector module is provided. The detector module includes a plurality of radiation detecting elements, a temperature sensor, and storing device for storing temperature characteristic information of sensitivities of the radiation detecting elements.

According to the above aspects, temperature characteristic information of sensitivities of radiation detecting elements necessary for temperature correction of data detected by the radiation detecting elements can be acquired, in detector module units, from a storing device with the temperature characteristic information written therein. For this reason, imaging for acquiring the temperature characteristic information can be saved, and time and effort are not taken for an imaging preparation even if each of the detector modules is replaced with another.

### BRIEF DESCRIPTION OF THE DRAWINGS

FIG. 1 is a schematic configuration diagram of an X-ray CT (Computed Tomography) apparatus.

FIGS. 2A-2C are schematic configuration diagrams of a detector module.

FIG. 3 is a diagram showing a processing flow including preparation and imaging processes of the X-ray CT apparatus.

FIG. 4 is a diagram showing a schematic configuration of an X-ray CT apparatus according to a second embodiment.

FIG. 5 is a diagram showing a schematic configuration of an X-ray CT apparatus according to a third embodiment.

### DETAILED DESCRIPTION OF THE INVENTION

Exemplary embodiments will hereinafter be described.

### First Embodiment

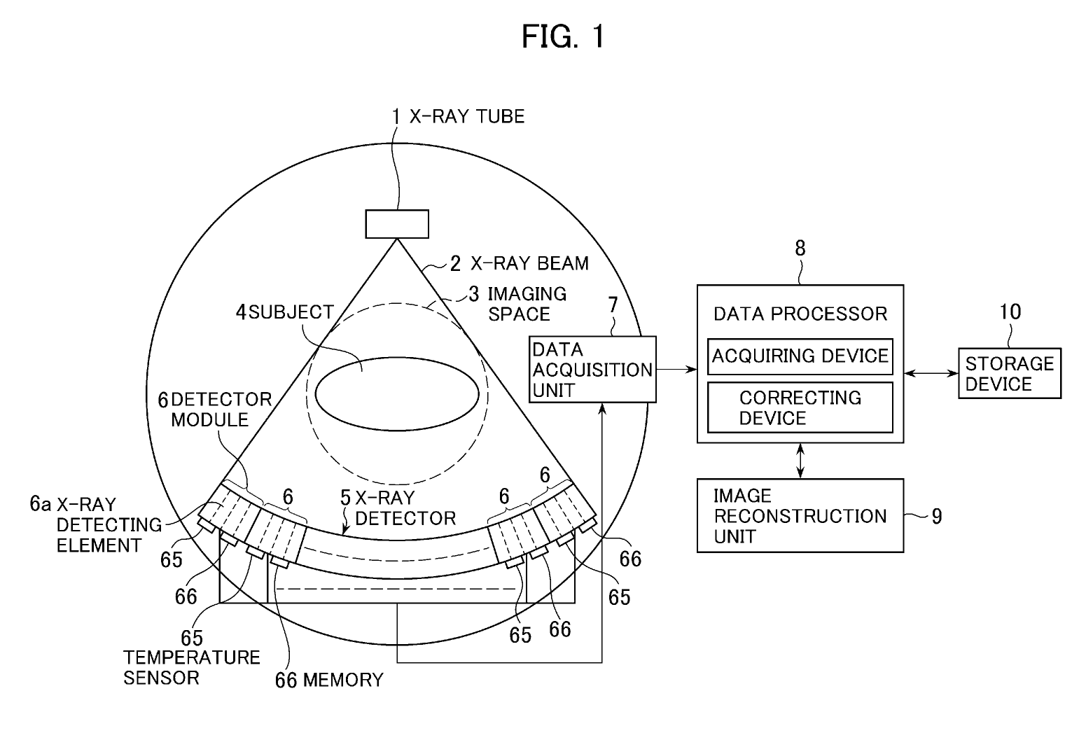

FIG. 1 is a schematic configuration diagram of an X-ray CT apparatus. As shown in FIG. 1, the X-ray CT apparatus is equipped with an X-ray tube 1, an X-ray detector 5, a data acquisition unit 7, a data processor 8, an image reconstruction unit 9 and a storage device 10.

The X-ray tube 1 and the X-ray detector 5 are disposed opposite to each other with an imaging space 3 interposed therebetween and supported rotatably around the imaging space 3. The X-ray tube 1 projects an X-ray beam 2 to the X-ray detector 5. The X-ray detector 5 is configured by a plurality of detector modules 6 disposed therein. The detector modules 6 include a plurality of X-ray detecting elements 6a respectively. X-ray incident planes of the X-ray detecting elements 6a are arranged in matrix form. The X-ray detector 5 detects X-rays penetrated through a subject 4 to be imaged placed in the imaging space 3, by the X-ray detecting elements 6a and outputs projection data that are their detected data. At scan, the X-ray tube 1 and the X-ray detector 5 are rotated so that the projection of the X-ray beam 2 and the detection of the X-rays penetrated through the subject 4 are performed.

The data acquisition unit 7 sequentially receives the projection data from the X-ray detector 5 during the scan to thereby acquire projection data of plural views.

The data processor 8 performs a pre-process including various corrections such as an offset correction, a reference correction, a temperature correction, etc. on the acquired projection data of plural views.

The image reconstruction unit 9 reconstructs an image by a back projection process or the like, based on the projection data of plural views after the pre-process.

The storage device 10 holds therein acquired correction coefficients for temperature correction, and the like in addition to programs for executing various processes and stores the acquired projection data, the reconstructed image and so on therein.

A configuration of the detector module 6 will next be explained in detail.

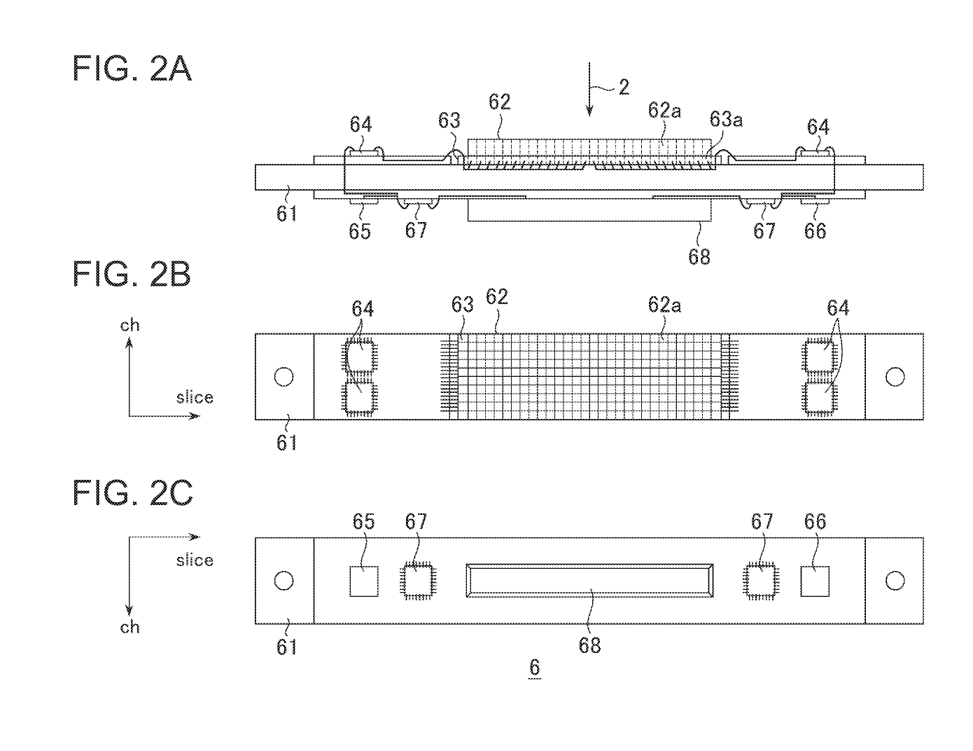

FIGS. 2A-2C are schematic configuration diagrams of the detector module 6, in which FIG. 2A is a side diagram, FIG. 2B is a plan diagram as viewed from the X-ray incident plane side, and FIG. 2C is a bottom diagram as viewed from the side opposite to the X-ray incident plane, respectively.

The scintillator array 62 includes a plurality of scintillators 62a arranged in matrix form in high density. For example, scintillators of about 1.25 mm square per side are arranged 32×128 in a channel direction and a slice direction. Each individual scintillator 62 emits light with the quantity of light corresponding to the incident X-ray.

The scintillator array 62 is comprised of a plurality of scintillators 62a arranged in matrix form in the high density. For example, scintillators of about 1.25 mm square per side are arranged 32×128 in a channel direction and a slice direction. Each individual scintillator 62 emits light with the quantity of light corresponding to the incident X-ray.

The photodiode array 63 includes a plurality of photodiodes 63a arranged in matrix form at substantially the same locations as the scintillators 62a. Each individual photodiode 63a receives emitted light from each of the scintillators 62a placed in their corresponding positions as viewed in the vertical direction and outputs an analog electrical signal corresponding to the quantity of the emitted light.

Each of the AD conversion circuits 64 is of, for example, an ASIC (Application Specific Integrated Circuit) or a PLD (Programmable Logic Device). The AD conversion circuit 64 converts the analog electrical signal from each photodiode 63a into a digital electrical signal and outputs it therefrom. Incidentally, the scintillator 62a, the photodiode 63a and the AD conversion circuit 64 that correspond to one another configure one X-ray detecting element 6a.

Each of the temperature sensors 65 outputs an electrical signal corresponding to an ambient temperature. The temperature sensor 65 may be configured as, for example, a platinum temperature sensor high in radiation resistance to suppress its deterioration due to the X-ray and disposed in a plane opposite to the X-ray incident plane of the base plate 61.

Each of the memories 66 is of, for example, a non-volatile memory such as an OTPROM (One-Time Programmable Read-Only Memory), an EPROM (Erasable Programmable ROM) or an EEPROM (Electrically Erasable Programmable ROM) or the like. The memory 66 stores therein data (hereinafter called temperature characteristic data) related to a temperature characteristic of the sensitivity of each X-ray detecting element 6a in the detector module 6 equipped with the memory 66. The temperature characteristic data is determined in advance by a predetermined method and written into the memory 66 outside the X-ray CT apparatus. The temperature characteristic data is obtained by, for example, examining the relationship between the input and output of a prescribed X-ray detecting element 6a at the detector module 6 under a first temperature (e.g., 36° C.) and under a second temperature (e.g., 38° C.) and determining fluctuations in gain and offset relative to changes in temperature, based on the relationship between these.

Meanwhile, the temperature characteristic of the sensitivity of each X-ray detecting element 6a at the detector module 6 may greatly vary depending on the solid matter of the detector module 6. This comes from a leading cause that makers, manufacturing factories, materials and the like differ depending on the detector modules 6, and their manufacturing conditions are not the same. On the other hand, since the X-ray detecting elements 6a in the same detector module 6 are approximately the same in manufacturing conditions, variations in the temperature characteristic of the sensitivity are small.

Thus, in the present embodiment, temperature characteristic data of one type representing one detector module 6 is associated with the detector module 6 using such characteristics of the detector module 6, and stored in the memory 66. The same temperature characteristic data associated with the same detector module 6 is used for any of the temperature corrections of the projection data obtained by the X-ray detecting elements 6a in the same detector module 6. It is thus possible to significantly reduce the number of times that the temperature characteristic data used in the temperature correction of the projection data is measured in advance and read/switched, and a storage space. The burden on the data processor 8 and the storage device can be reduced, and the temperature characteristic data can be simply measured and managed.

In the present embodimemt as well, the temperature characteristic data is assumed to be a correction coefficient used in the temperature correction of the projection data. Thus, since it is possible to save time and effort taken to derive a correction coefficient from the temperature characteristic of the sensitivity, the efficiency of a correction arithmetic operation can be enhanced.

Each of the data communication circuits 67 is connected to the data acquisition unit 7 through a connector 68 and an unillustrated cable. The data communication circuit 67 receives the output of the AD conversion circuit 64, i.e., the projection data, the output of the temperature sensor 65, and the temperature characteristic data stored in the memory 66, and appropriately outputs data to the data acquisition unit 7.

The data acquisition unit 7 inputs the data outputted from the data communication circuit 67 therein and appropriately outputs the data to the data processor 8.

Incidentally, the memory 66 is one example of a storing device, and the data processor 8 is one example illustrative of an acquiring device and a correcting device.

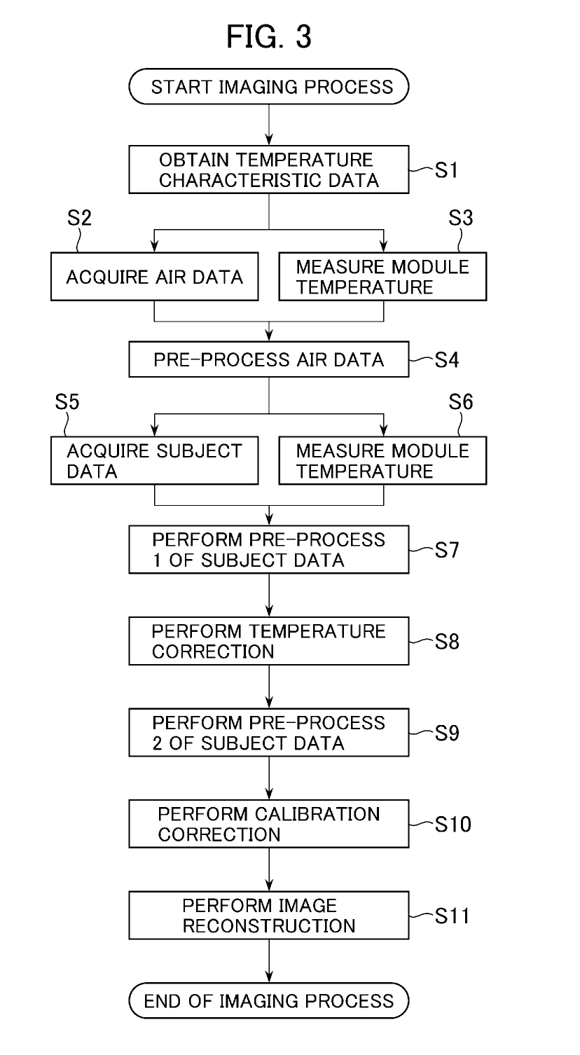

An imaging process including a temperature correction for projection data at the X-ray CT apparatus will next be explained with reference to FIG. 3.

A processing flow including preparation and imaging processes of the X-ray CT apparatus is shown in FIG. 3. Steps S1 to S4 correspond to the preparation process, and steps S5 to S10 correspond to the imaging process.

At Step S1, the temperature characteristic data stored in the memory of each detector module (i.e., the correction coefficient used for the temperature correction of the projection data) is read and acquired.

The next steps S2 and S3 correspond to a parallel process.

At step S2, air is scanned and air data corresponding to projection data at this time are acquired.

At step S3, the outputs of the temperature sensors 65 of the respective detector modules 6 at the acquisition of the air data are obtained. Temperatures Tcal (m), m=1, 2, . . . , and me of the respective detector modules 6 are determined. Here, m indicates a module number, and me indicates the number of detector modules 6 that configure the X-ray detector 5. Incidentally, the output of each temperature sensor 65 may be obtained immediately before or after the acquisition of the air data.

At step S4, a pre-process related to a so-called offset correction, logarithmic transformation, a reference correction, a beam hardening correction, etc. is performed on the air data to thereby obtain the pre-processed air data dcal.

The following steps S5 and S6 correspond to a parallel process.

At step S5, a subject to be imaged is scanned, and subject data corresponding to projection data at this time are acquired.

At step S6, the outputs of the temperature sensors 65 of the respective detector modules 6 at the acquisition of the subject data are obtained. The temperatures Tobj (m), m=1, 2, . . . , and me of the respective detector modules 6 are determined. Incidentally, the output of each temperature sensor 65 may be obtained immediately before or after the acquisition of the subject data.

At step S7, the so-called offset correction is performed on the subject data as a pre-process 1.

At step S8, a temperature correction is performed on the subject data subsequent to the offset correction. That is, in consideration of the temperature characteristic of the sensitivity of each X-ray detecting element 6a, the subject data is converted into data estimated to be obtained where acquired at the same temperature as when the air data are acquired. For example, the following correction operational equation (Equation 1) is used for temperature correction.

d′obj(m)={dobj(m)−doffset (m)}

x{1+Σi[αi(m)·(Tobj(m)−Tcal(m))ⁱ]} Equation 1

Here, dobj (m) indicates the offset-corrected subject data obtained by the X-ray detecting element 6a at the detector module 6 of the module number m, doffset (m) indicates an offset of the output of the X-ray detecting element 6a at the detector module 6 of the module number m, and d′obj (m) indicates temperature-corrected subject data after a temperature correction is further performed on the offset-corrected subject data. Further, αi (m) indicates an i-order correction coefficient. The correction coefficient has been stored as the temperature characteristic data in the memory 66 provided in the detector module 6 of the module number m. The correction coefficient is based on the temperature characteristic of the sensitivity specific to the detector module 6.

Incidentally, there is also considered, as the correction operational equation, a correction operational equation including a multidimensional correction coefficient by which multidimensional terms are multiplied, such as a second-order correction coefficient by which a second-order term {dobj (m)}² is multiplied, a third-order correction coefficient by which a third-order term {dobj (m)}³ is multiplied, or the like.

At step S9, a pre-process 2 including logarithmic transformation, a reference correction, a beam hardening correction, etc. is further performed on the temperature-corrected subject data d′obj to thereby obtain pre-processed subject data d″ obj.

At step S10, a calibration correction (also called air correction) is performed on the pre-processed subject data d″ obj using the pre-processed air data. That is, the temperature-corrected subject data is corrected in such a manner that the relationship between an X-ray absorption coefficient of a substance and a pixel value (CT value) of a reconstructed image becomes effective as prescribed.

At step S11, an image reconstruction process is performed using the calibration-corrected subject data.

Incidentally, it is desirable that the X-ray CT apparatus has the function of automatically obtaining temperature characteristic information corresponding to new detector modules 6′ when some detector modules 6 that configure the X-ray detector 5 are replaced with the new detector modules 6′.

According to the present embodiment as described above, the memory 66 provided in each detector module 6 has stored therein the data about the temperature characteristics of the sensitivities of the X-ray detecting elements 6a at the detector module 6. For this reason, there is no need to perform in advance a scan for determining the temperature characteristic data necessary for the temperature correction of the projection data on the X-ray CT apparatus side. It is possible to perform the imaging preparation more easily.

In particular, there has heretofore been a need to purposely perform the work of redetermining temperature characteristics corresponding to a newly-provided detector module 6′ each time the detector module 6 of the X-ray detector 5 is replaced with another. The present embodiment, however, makes this work unnecessary.

Further, since the detector module 6 has its own temperature characteristic data, it is not necessary to carry a storage medium having stored temperature characteristic data therein as a set together with the detector module 6 and input temperature characteristic data manually. It is therefore easy to deal with it.

### Second Embodiment

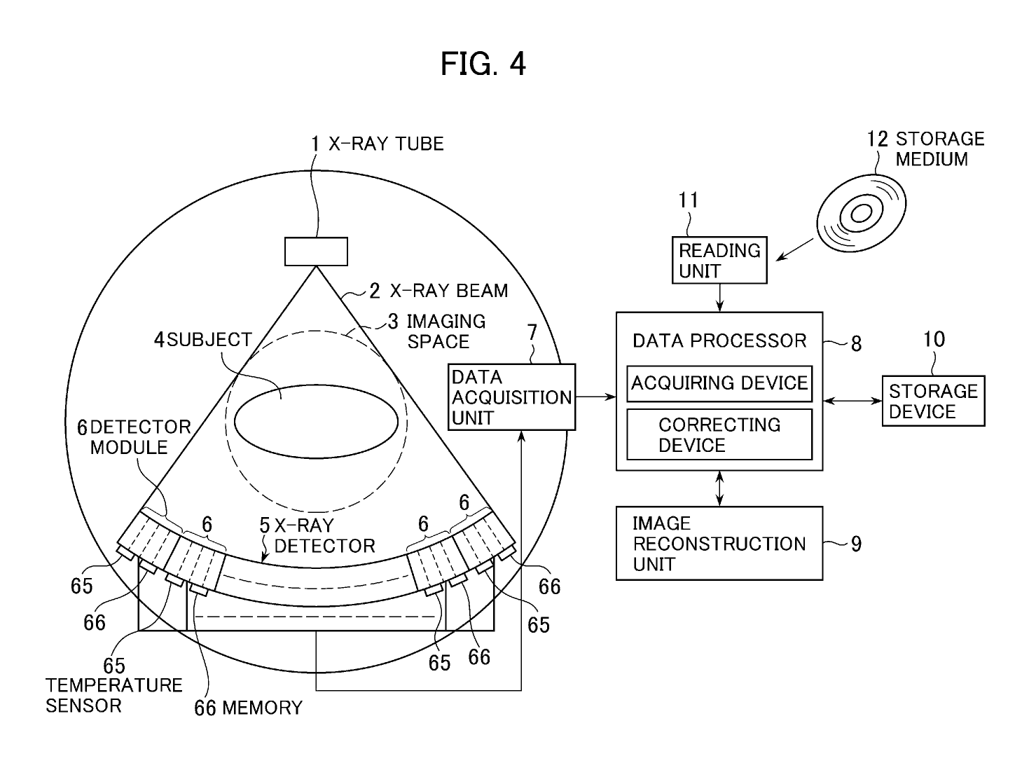

FIG. 4 is a diagram showing a schematic configuration of an X-ray CT apparatus according to a second embodiment.

In the second embodiment, the X-ray CT apparatus has a reading unit 11 of a storage medium. A storage medium 12 readable by the reading unit 11 stores therein temperature characteristic data of each detector module 6. The temperature characteristic data is determined by a prescribed method and stored in the storage medium 12 outside the X-ray CT apparatus. The storage medium 12 is managed as a set by attachment to each detector module 6 or the like. A data processor 8 of the X-ray CT apparatus reads and acquires the temperature characteristic data stored in the storage medium 12 through the reading unit 11. As the storage medium 12, there are various media such an IC card equipped with an IC chip, printed matters such as a bar code, a QR code and the like in addition to optical discs such as a CD-ROM, a DVD-ROM, etc., a magnetic disc such as an FD (Flexible Disk), a semiconductor memory such as a USB memory. Incidentally, the storage medium 12 is one example of a storing device. The data processor 8 is one example illustrative of an acquiring device and a correcting device.

For example, the X-ray CT apparatus has CD-ROM drive as the reading unit 11. A detector module 6 has a memory 66 in which a maker thereof and a production lot number thereof have been written. The CD-ROM is attached to the detector module 6 as the storage medium 12. Temperature characteristic data have been written into the CD-ROM with every maker and production lot number of the detection module 6 in association therewith. The data processor 8 of the X-ray CT apparatus reads the maker and the production lot number from the memory 66 of each detector module 6 and reads and acquires the temperature characteristic data corresponding thereto from the CD-ROM.

According to such a second embodiment, the temperature characteristic data can be modified and updated afterwards. Thus it becomes easy to manage the temperature characteristic data.

### Third Embodiment

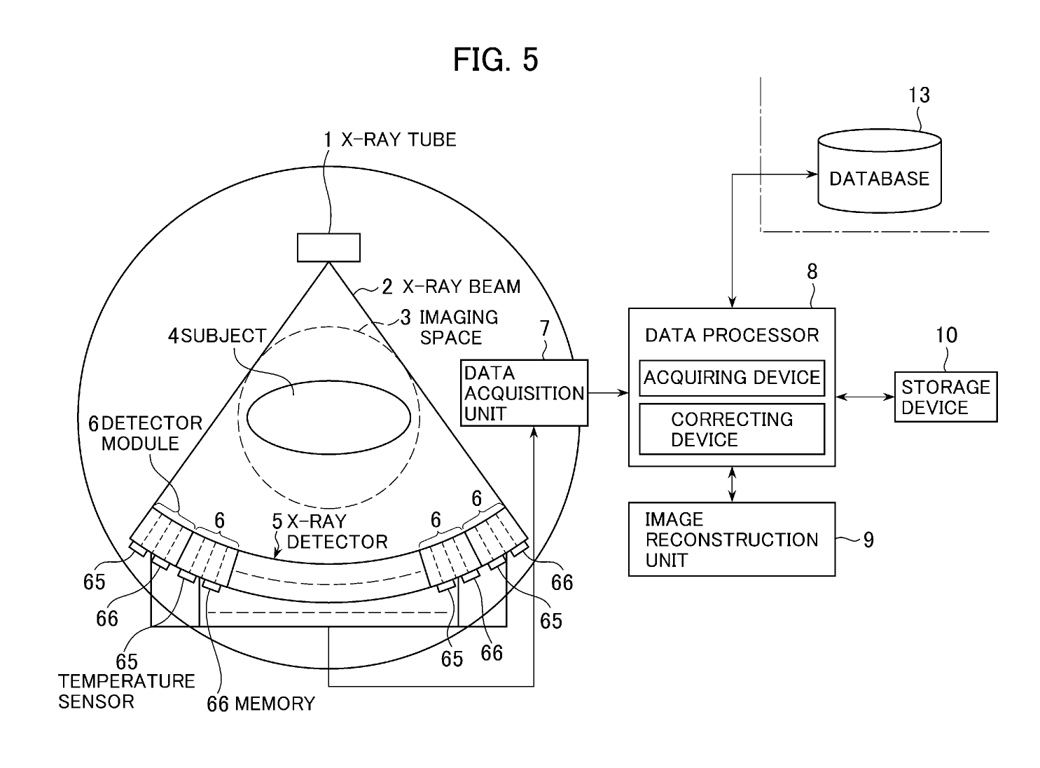

FIG. 5 is a diagram showing a schematic configuration of an X-ray CT apparatus according to a third embodiment.

In the third embodiment, the X-ray CT apparatus is connected to a database 13 through a network. The database 13 stores temperature characteristic data of each detector module 6 therein. The temperature characteristic data is determined by a prescribed method in advance and stored in the database 13 outside the X-ray CT apparatus. A data processor 8 of the X-ray CT apparatus identifies the individual detector modules 6 that configure an X-ray detector 5 and reads and acquires the temperature characteristic data corresponding to the identified detector modules 6 from the database 13. The location to provide the database 13 is not limited in particular. The network is irrespective of whether or not it is wired or wireless. Incidentally, the database 13 is one example of a storing device. The data processor 8 is one example illustrative of an acquiring device and a correcting device.

For example, the detector module 6 has a memory 66 in which a maker thereof and a production lot number thereof have been written. The database 13 is located outside a facility where the X-ray CT apparatus is provided. The database 13 is managed by the maker of the X-ray CT apparatus. Temperature characteristic data have been stored into the database 13 every maker and production lot number of the detection module 6 in association therewith. The X-ray CT apparatus reads the maker and the production lot number from the memory 66 of each detector module 6 and reads and acquires the temperature characteristic data corresponding to an identification code thereof from the database 13.

According to such a third embodiment, the temperature characteristic data can be modified and updated afterwards. Thus it becomes easy to manage the temperature characteristic data. Since no storage medium is used, the parts cost of the storage medium and its management cost become unnecessary.

Although exemplary embodiments have been described above, the present invention is not limited to the aforementioned embodiments. Various additions and modifications can be made in a scope without departing from the gist of the invention.

In the above embodiments, one type of typical temperature characteristic data is associated with one detector module 6 for the purpose of a reduction in the burden on the data processor 8 and the storage device 10 and simplification of the measurement and management of the temperature characteristic data. When, however, there are allowances for throughput of the data processor 8 and the storage space of the storage device 10, and the measurement and management of the temperature characteristic data are in good order, a plurality of types of temperature characteristic data may be associated with one detector module 6. For example, a plurality of X-ray detecting elements 6a that configure one detector module 6 are divided into a plurality of groups. Typical temperature characteristic data of the groups may be associated one by one every group. The temperature characteristic data associated with the groups may be used for the temperature correction of data detected by the X-ray detecting elements 6a in the same group. Alternatively, the temperature characteristic data of the X-ray detecting elements 6a that configure one detector module 6 may be associated with the X-ray detecting elements 6a one by one every X-ray detecting element 6a. The temperature characteristic data associated with the X-ray detecting elements 6a may be used for the temperature correction of the data detected by the individual X-ray detecting elements 6a. This enables a temperature correction higher in accuracy.

Although the temperature characteristic data are set as the correction coefficients used for temperature correction of the projection data in the above embodiment, the temperature characteristic data may include not only the correction coefficients but also the correction operational equations. The temperature characteristic data are set as the relationship between temperatures, gain and offsets. The data processor 8 side may derive the correction coefficients and the correction operational equation based on the relationship between these to perform a temperature correction.

In the above embodiment, the air data is used for the calibration correction, but water data obtained by scanning water instead of air may be used therefor.

In the above embodiment, each X-ray detecting element 6a includes the scintillator 62a, the photodiode 63a and the AD conversion circuit 64, but alternatively, may be only include the scintillator 62a and the photodiode 63a. The AD conversion circuits 64 may be provided outside the detector module 6.

In the above embodiment, the temperature characteristic data is of data related to the temperature characteristic of the sensitivity of the entire X-ray detecting element 6a, but may be data related to temperature characteristics of any one or plural of the scintillator 62a, photodiode 63a and AD conversion circuit 64.

In the above embodiment, the temperature of each detector module 6 at the acquisition of the air data is determined and the temperature correction of the subject data is performed using the determined temperature. However, when the output of the temperature sensor 65 of each detector module 6 is monitored and the average temperature of the detector module 6 reaches a predetermined reference temperature, air data are acquired. A temperature correction may be performed using the reference temperature as the temperature of the detector module 6 at the acquisition of the air data. It is thus possible to achieve an improvement of the efficiency of a correction operation.

Although the exemplary embodiments are examples involving an X-ray CT apparatus, the methods and systems described herein may be applied to any radiation imaging apparatuses each having a radiation detector including a plurality of detector modules. For example, the methods and systems described herein can also be applied to a general X-ray imaging apparatus for chest and breasts.

1. A radiation imaging apparatus comprising:
a radiation detector comprising a plurality of detector modules disposed therein, each detector module comprising a plurality of radiation detecting elements,
wherein each of the detector modules comprises a temperature sensor, and
wherein the radiation imaging apparatus further comprises:
an acquiring device configured to acquire temperature characteristic information of sensitivities of the radiation detecting elements from a storing device in which the temperature characteristic information is stored in advance; and
a correcting device configured to correct data detected by the radiation detecting elements, based on temperature information acquired by the temperature sensor and the temperature characteristic information acquired by the acquiring device.

2. The radiation imaging apparatus according to claim 1, wherein each of the detector modules comprises the storing device.

3. The radiation imaging apparatus according to claim 1, further comprising a reading unit,
wherein the storing device is a storage medium readable by the reading unit.

4. The radiation imaging apparatus according to claim 1, wherein the storing device is connected to the radiation imaging apparatus through a network.

5. The radiation imaging apparatus according to claim 1,
wherein the temperature characteristic information includes temperature characteristic information of the detector modules, and
wherein the correcting device is configured to correct data detected by the radiation detecting elements, based on the temperature characteristic information of the detector modules.

6. The radiation imaging apparatus according to claim 1,
wherein the temperature characteristic information includes temperature characteristic information for each of a plurality of groups of radiation detecting elements, and
wherein the correcting device is configured to correct data detected by the radiation detecting elements in the same group, based on the typical temperature characteristic information of the groups.

7. The radiation imaging apparatus according to claim 1,
wherein the temperature characteristic information includes temperature characteristic information for every radiation detecting element, and
wherein the correcting device is configured to correct the data detected by the radiation detecting elements, based on the temperature characteristic information of the radiation detecting elements.

8. The radiation imaging apparatus according to claim 1, wherein when the detector module is replaced with a new detector module, the correcting device is configured to acquire temperature characteristic information corresponding to the new detector module.

9. The radiation imaging apparatus according to claim 1, wherein the correcting device is configured to perform the correction, based on temperature information acquired by the temperature sensor at a time that water or air is imaged, and temperature information acquired by the temperature sensor at a time that a subject to be captured is imaged.

10. The radiation imaging apparatus according to claim 1,
wherein each radiation detecting element comprises a scintillator and a photodiode, and
wherein the temperature characteristic information includes information related to a temperature characteristic of an output of the photodiode.

11. The radiation imaging apparatus according to claim 10, wherein the temperature characteristic information includes information related to a temperature characteristic of an output of the scintillator.

12. The radiation imaging apparatus according to claim 1,
wherein each of the radiation detecting elements includes a scintillator, a photodiode, and a circuit configured to receive the output of the photodiode as an input, and
wherein the temperature characteristic information includes information related to a temperature characteristic of an output of the circuit.

13. The radiation imaging apparatus according to claim 1, wherein the temperature characteristic information includes information indicative of variations in at least one of gain and offset relative to the temperature.

14. The radiation imaging apparatus according to claim 1, wherein the temperature characteristic information includes at least one of a correction operational equation and correction coefficients used for the correction of the detected data.

15. The radiation imaging apparatus according to claim 1, wherein the temperature sensor is disposed on a side opposite to a radiation incident side of each of the detector modules.

16. The radiation imaging apparatus according to claim 1, wherein the temperature sensor is a platinum temperature sensor.

17. The radiation imaging apparatus according to claim 1, wherein the radiation imaging apparatus is configured to perform X-ray CT imaging.

18. A detector module comprising:
a plurality of radiation detecting elements;
a temperature sensor; and
a storing device for storing temperature characteristic information of sensitivities of the radiation detecting elements.

19. The detector module according to claim 18, wherein each radiation detecting element comprises a scintillator and a photodiode, and wherein the temperature characteristic information includes information related to a temperature characteristic of an output of the photodiode.

20. A method for operating a radiation imaging apparatus, said method comprising:
providing a plurality of detector modules each including a plurality of radiation detecting elements, wherein each detector module includes an associated temperature sensor;
storing temperature characteristic information on a storing device; and
correcting data detected using the radiation detecting elements, based on the stored temperature characteristic information and temperature information acquired by the temperature sensors.
